(19) United States
(12) Patent Application Publication
(10) Pub. No.: US 2012/0169457 A1
(43) Pub. Date: Jul. 5, 2012

(54) METHOD AND SYSTEM FOR DYNAMICALLY ASSIGNING ACCESS RIGHTS

(75) Inventor: Jon L. Williamson, Newburyport, MA (US)

(73) Assignee: SCHNEIDER ELECTRIC BUILDINGS AB, MALMO (SE)

(21) Appl. No.: 12/982,950

(22) Filed: Dec. 31, 2010

(51) Int. Cl. G08B 29/00; G06F 17/30

(52) U.S. Cl. 340/5.2; 707/609; 707/E17.005

(57) ABSTRACT

The system and method take changes in a person's or groups' status and by following a series of steps (rules) ensures that the person or groups are given proper access to a secure location. The system has at least one access control device for controlling the flow of persons in a physical setting to at least one secure area. An access control database of the system contains information regarding criteria for allowing access to the at least one secure area. A control system receives information from the at least one access control device and compares it to the access control database to determine if access is to be granted. A rules unit gathers information from various sources and updates the access control database.

### FIELD OF THE INVENTION

The present invention relates to physical security and access control and more particularly to dynamically assigning rights to individuals or groups.

### BACKGROUND OF THE INVENTION

It is common to limit access to physical locations through access control systems. The access control system can vary in complexity from a latch a child cannot reach to biometrics such as a fingerprint or retina reader. Some of the more common systems include proximity cards and other credentials, where the card or other credential is tied to a particular individual.

The access control systems control the access to secure areas through the assignment of access rights to an individual, group, or department. The access rights can be assigned to limit access to an area for particular days and times. Furthermore, access can be further limited or increased by conditions and privilege. As a result, an operator who has access throughout a building may be limited to certain areas at certain times, privileges, and conditions.

### SUMMARY OF THE INVENTION

It has been recognized that the assignment of access rights in access control systems has been a static process. The rights are either assigned mutually from the access control system, or imported and assigned to a group of access permissions based on one property, such as department. Once set, the rights need manual and regular administration.

In an embodiment of a security system for allowing access to secure areas according to the invention, the system has at least one access control device for controlling the flow of persons in a physical setting to at least one secure area. An access control database contains information regarding criteria for allowing access to the at least one secure area. A control system receives information from the at least one access control device and compares the information to the access control database to determine if access is to be granted. A rules unit gathers information from various sources and updates the access control database.

In an embodiment, the rules unit includes a mechanism for gathering information from other databases. The unit includes a mechanism for updating a database related to personnel. In addition, the unit has a mechanism for updating the access control database.

In an embodiment, the rules unit has a personnel database and an organizational database for use in determining the settings in the access control database.

In an embodiment, the periodicity for which the rules unit gathers information and updates the access control database can be varied.

In a method of dynamically updating access rights, an access control database contains information regarding criteria for allowing access through an access control device to at least one secure area. Information is gathered related to personnel from at least one source. A personnel access database is updated related to personnel based on the gathered information. The access control database is updated by running information from the personnel access database through a rules engine that contains criteria for at least one access control device.

In an embodiment, the rules engine uses both the personnel access database and an organizational database in determining the criteria for the at least one access control device.

In an embodiment, the sources are a plurality of databases. In an embodiment, the plurality of record databases are selected from the group of training, project, and human resources.

These aspects of the invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a pictorial display of a building security system;

FIG. 2 shows a pictorial display of an industrial complex security system;

FIG. 3 is a schematic of a system for controlling a building's physical access control system;

FIG. 4 is a pictorial display of a rule matrix;

FIG. 5 is a schematic of a method of adjusting privileges; and

FIG. 6 is a schematic of interacting systems.

### PREFERRED EMBODIMENTS OF THE INVENTION

The system and method takes changes in a person's or groups status and by following a series of steps (rules) ensures that the person or groups are given proper access. The system has at least one access control device for controlling the flow of persons in a physical setting to at least one secure area. An access control database of the system contains information regarding criteria for allowing access to the at least one secure area. A control system receives information from the at least one access control device and compares it to the access control database to determine if access is to be granted. A rules unit gathers information from various sources and updates the access control database.

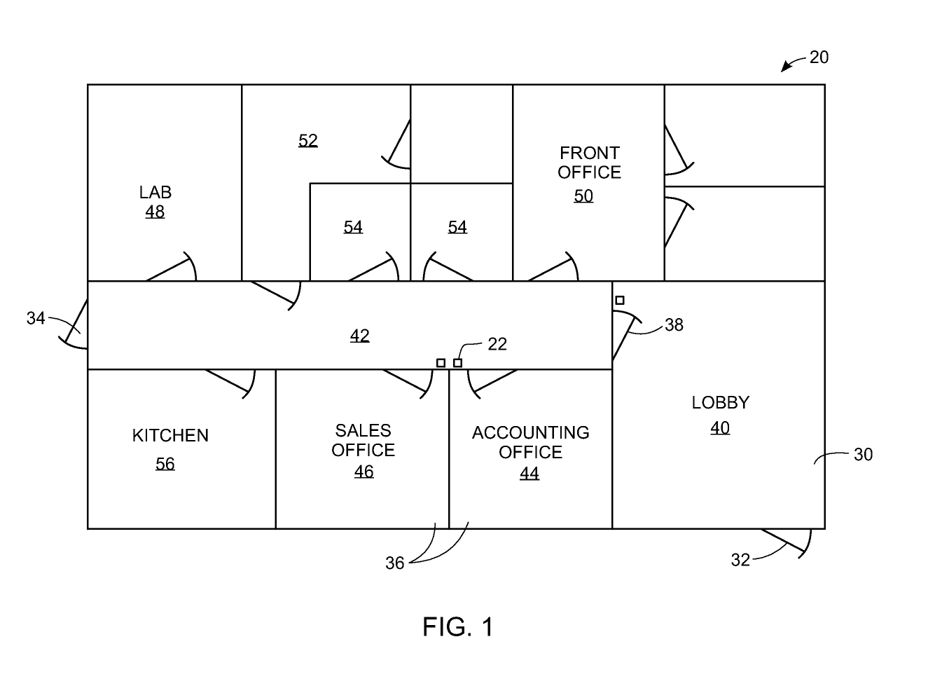

Referring to FIG. 1, a pictorial display of a security system 20 for the building 30 is shown. In this simplistic representation, the building 30 is shown having a front entrance 32 and a back entrance 34. In addition, the building 30 has a plurality of rooms 36, some of which have access control devices 22. In addition, the building 30 has an access control device 22 between a front lobby 40 and a hallway 42; this door is referenced as 38. It is recognized during the business day certain access control devices 22 may be switched to another mode with a security system 20 that does not limit access between specific locations such as between the lobby 40 and the hallway 42 or in the alternative the front entrance 32.

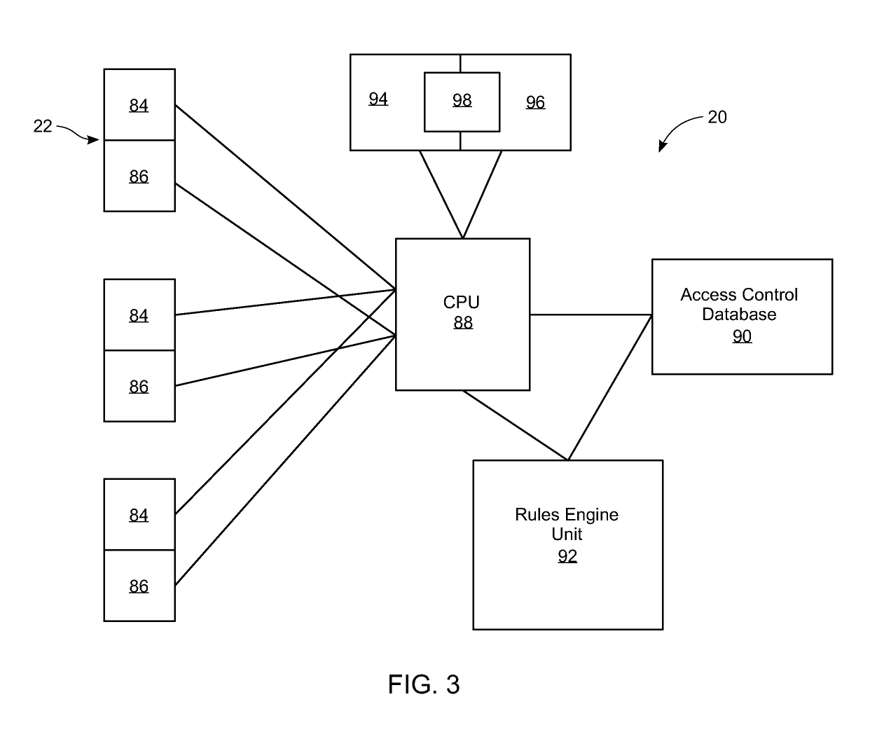

Still referring to FIG. 1, in this embodiment, each employee has a proximity card that is required to open certain doors, such as an accounting office 44, sales office 46, lab 48, a front office suite 50, and a facility/IT suite 52. It is recognized that other locations such as a restroom 54 and a kitchen 56 do not have access systems. In a conventional system, an access control database 90, as shown in FIG. 3 would list personnel such as employees and the particular doors and times to which the employee is allowed access. Table 1 shows a representation of a small portion of the database 90. If a particular employee's situation changes, such as switching shifts, or jobs, the operator of the security system 20 would go into the database 90 and adjust the individual's privileges.

TABLE 1
Access Control Information for Back Door and Lab

| | | | Back | | | |
|---|---|---|---|---|---|---|
| | Back | Back | Door | | | Lab |
| | Door | Door | Other | Lab | Lab | Other |
| Employee | 1st Shift | 2^{nd} Shift | time | 1^{st} Shift | 2nd Shift | time |
| A | Yes | Yes | Yes | Yes | No | Yes |
| B | Yes | No | No | Yes | No | No |
| C | Yes | No | No | Yes | Yes | No |
| D | Yes | Yes | No | No | No | No |
| E | No | Yes | No | No | Yes | No |
| F | No | Yes | No | No | Yes | No |
| G | No | No | Yes | No | No | Yes |
| H | Yes | No | No | No | No | No |

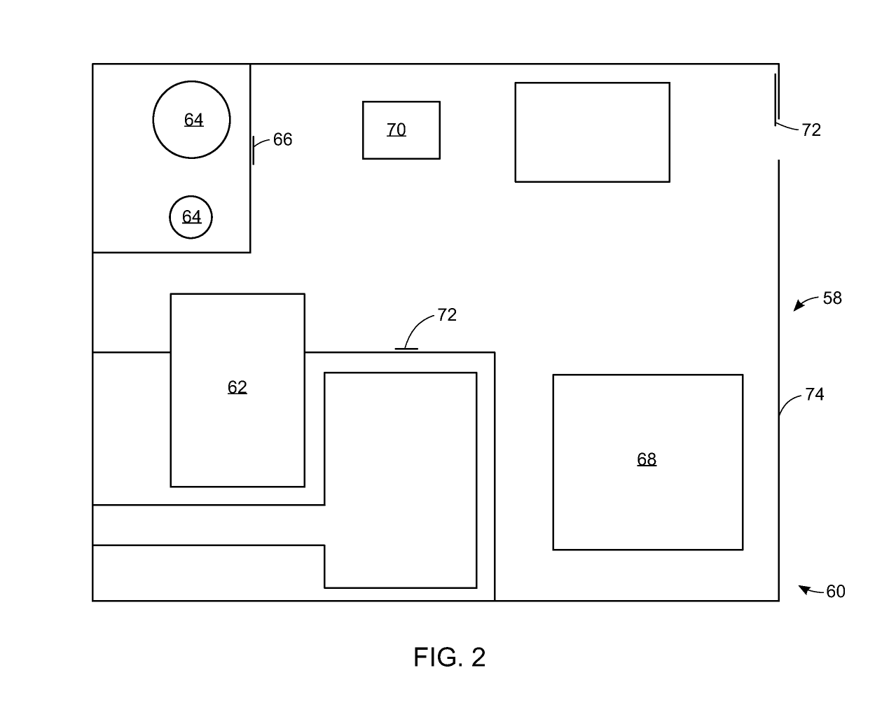

Referring to FIG. 2, a pictorial display of an industrial complex 60 and its associated security system 58 is shown. While FIG. 1 showed a building 30 and table 1 shows eight (8) employees, it is recognized that the industrial complex 60 as shown in FIG. 2 would have numerous more employees and control access points using the access control device 22 than the building 30 shown in FIG. 1. The representation shown in FIG. 2 shows a main office building 62 that could have many stories and various suites including sales, accounting, labs, and computer all with specific access requirements. In addition, individual labs may have different access requirements or individual rooms within suites may have different access requirements. Likewise, the system could have other items such as storage tanks 64 and associated gates 66 that would have additional or different requirements. Likewise, other facilities such as a manufacturing building 68 or an explosives building 70 could have additional requirements. Likewise, the industrial site 60 could have various types of gates 72 in walls or fences to limit access to particular areas of the site.

An operator of such a system 58 would be overwhelmed with manually updating access based on changes related to situations and personnel.

Referring to FIG. 3, a schematic of the security system 20 for controlling a building or other physical access control system is shown. The security system 20 has a plurality of access control devices 22 including an input mechanism 84 and an access restrictor or output device 86 for monitoring and granting access to locations. In order to gain access to a certain physical location, a user needs to provide authentication to the access control device 22 through the input mechanism 84. The authentication can be in various forms including, but not limited to a proximity card that is placed in proximity to a proximity card reader which is part of the input mechanism 84. Another alternative is a keypad or swipe card reader in which the user either enters their code or swipes their card. Another credential alternative includes RFID, reader, and tags.

The access control device 22 such as a proximity card are forms of credentials. Credentials limit access by controlling at least one of three items of have, know, or about. For example, the user would Have a card. A user would Know a PIN. Biometrics is About a user.

The security system 20 has a controller or central processing unit 88 for controlling the security system 20. The CPU 88 accesses the access control database 90 that contains information related to access privileges and the information received from the input mechanism 84 of the access control device 22 is compared to determine if the access restrictor output device 86 should be set to allow access. The access restrictor output device 86 could be an electronic latch, mechanic latch, or a gate. The security system 20, in addition, has a rules engine unit 92 that takes information related to individuals or groups and modifies the access database 90 as explained in further detail below.

Still referring to FIG. 3, the security system 20 includes an interface device 94 for receiving operator input and a graphical display system 96 for an operator to control the security system 20. In another embodiment, the interface device 94 is a keyboard and a point of control such as a mouse or tracker ball. In another embodiment, the interface device 94 and the graphical display system 96 are incorporated into one device such as a touchscreen 98.

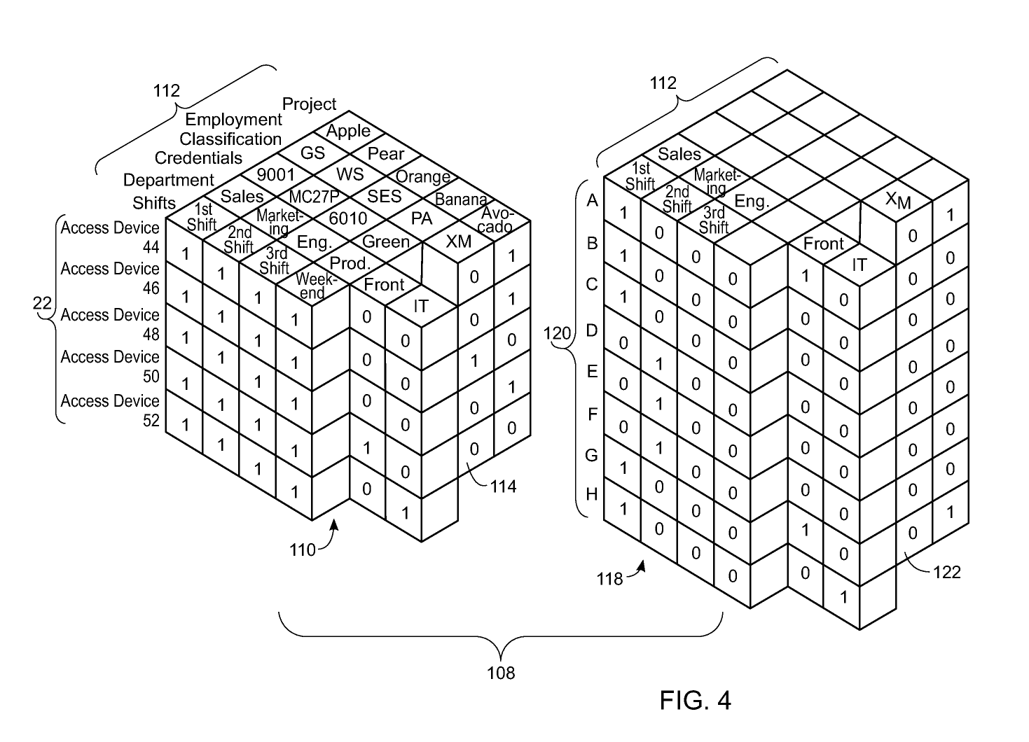

Referring to FIG. 4, a simplistic representation of a rules table 108 used in a rules engine unit 92 is shown. On the left side of the figure, there is an organizational database 110 which lists a series of access control devices 22 associated with building 30 of FIG. 1. The list is only a partial list and the list would continue downward and include each access control device 22. Across the top portion of the block is a plurality of criteria 112 including shift, department, credentials, employment classification, and project. The associated blocks 114 are propagated with yes and no or in the alternative ones and zeros. In that the table is three dimensional, only the first set of numbers is displayed.

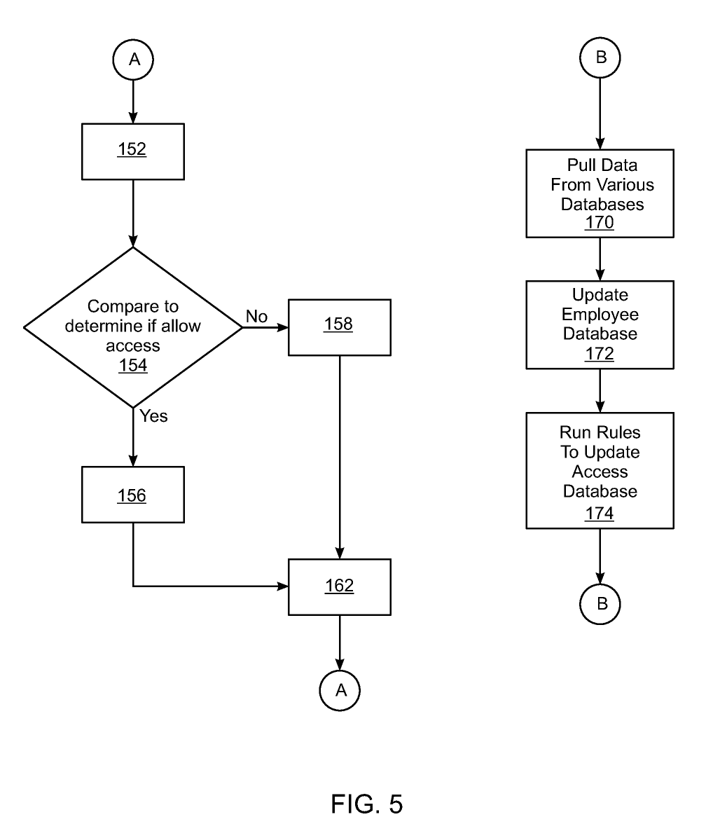

Depending on the particular rule as explained in further detail related to FIG. 5, a certain number or combination of “yes”es must be applicable for the user to pass through the associated door/gate with the access control device 22.

Still referring to FIG. 4, a second table or database, a personnel database 118, shown on the right side of the FIG., listing employees 120 and their particular status or criteria 112 is shown. If an employee's 120 status 112 changes, the affected block 120 is changed as explained below. For example if employee “B” receives certificate 9001, the code would be changed to 1. Likewise, if employee “C” switches from project “Apple” to project “Pear,” the code in the respect boxes would flip from “1” to “0” and “0” to “1” respectively. The process for changing the codes is explained below.

It is recognized that the above are just some potential criteria. Other criteria could include sex, citizenship, vehicle, and class enrollment. It is also recognized that times and shifts can be addressed by various methods. For example, an individual, group associated with a project, or other group can be tied to a shift. The access time related to the shift can be changed by the security system 20 to reflect a shift in start time such as from 7:30 AM to 6:15 AM, to reflect a holiday, or other situation change. In addition, the term shift can have two distinct meanings. A person or group can be assigned to a shift, such as a 1^{st}, 2^{nd}, or 3^{rd} shift. In addition, shift can relate to access time such as a person or group can gain access one or more of these shifts and/or weekends and holidays. The operator of the security system 20 can define the system to incorporate both.

Referring to FIG. 5, a schematic of a method for determining access is shown. The security system 20 receives a request to grant access to a specific location from an input mechanism for a particular door in the building 30 as seen in FIG. 1 and represented as block 152 as seen in FIG. 4. The security system 20 compares the request to the authorization as stored in the access database 90 and represented by decision diamond 154. If the authorization is proper, then the security system 20 grants access to the user by sending a signal through the access restrictor 86 as represented by block 156. If the authorization is not proper, then the security system 20 does not grant access to the access restrictor 86 as represented by block 158.

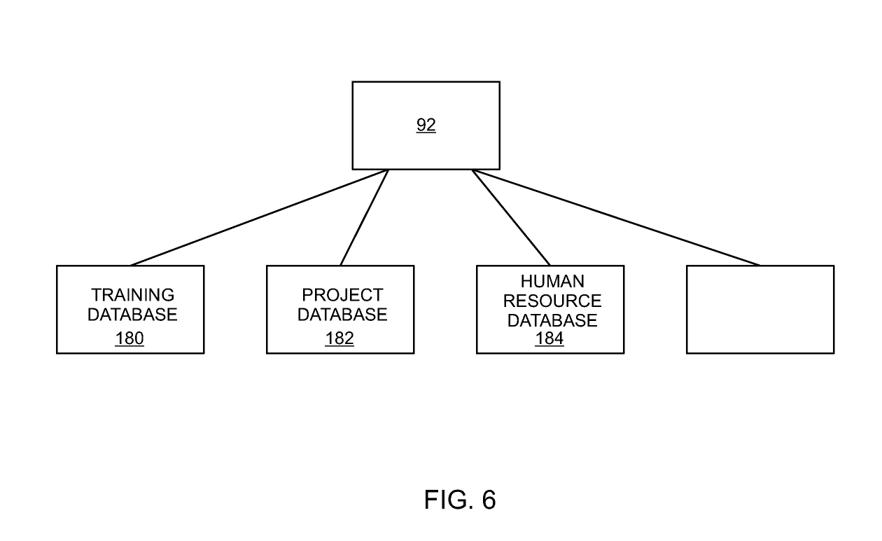

The security system 20 in addition to granting access, updates the access database 90, as seen in FIG. 1, by pulling information from various sources, such as a training database 180, a project database 182, and a human resources database 184 as seen in FIG. 6. The pulling of information is represented by block 170 in FIG. 6. With the updated information from the various sources such as described above, the security system 20 updates the personnel (employee) database 118 shown in FIG. 4, as represented by block 172.

With the personnel (employee) database 118 updated, the system runs in the rules engine unit 92 the rules which take information from both the organizational database 110 and the personnel database 118 to ensure that the access control database 90 is current. This step is represented by block 174 in FIG. 5.

Referring to FIG. 6, a schematic showing the interaction of various devices is shown. The rules engine unit 92 draws information from various items such as databases. The databases include the training database 180, the project database 182, the human resources database 184, and other databases. For example, another database could be an identity management system (IDMS). The identity management system and other databases could include not only positive traits such as certificates, but also negative traits that are relevant to the system such as sex offender register.

As way of example, John, an employee, is transferred from one department to another. The security system 20 would take this information by the rules engine unit 92 pulling the information from the human resources database 184 as represented by block 170 in FIG. 5. The personnel database 118 is updated to change the respective blocks 122, as seen in FIG. 4, and represented by block 172 in FIG. 5. The system 20 then runs rules pulling information from both the organizational database 110 and the personnel database 118 to ensure that the access control database 90 is current. This change in department may not effect anything in the access control database 90, change a single setting, such as 3^{rd} shift for one access point, or multiple settings.

Likewise, if Joe, an employee, receives a certain training certificate, the system 20 pulling information from the training database 180 would ensure that the access control database 90 is current.

While the above examples relate to individual employees, the change could be changes to groups or projects. In this situation, the organizational database 110 would be changed. For example, if a production schedule required employees typically not allowed to enter on a weekend or different shift to be required to be in a particular lab, then the security system 20 takes the production information and runs it through the set of rules modifying various employees or groups of employees access to various locations.

While shifts are shown as criteria 112 in the organizational database 110, shifts could be both a criteria and limiting factor related to access points as shown in Table 1.

As indicated above, the blocks of the organizational database 110 and the personnel database 118 are represented by “1” and “0” for yes and no. The access control database 90 is determined on rules engine unit 92 that at first glance may not be obvious. For example, if employee “A” has “1” for 1^{st} shift, front office, GS, apple, pear and overhead, the rules may allow her access to the front office 50, as seen in FIG. 1, all shifts but the Lab 48 only the 1^{st} shift and no access to the sales office 46 or the facility/IT suite 52. The change of one criteria could depend on the rules established by the operator.

While it is contemplated that the system 20 will pull data from various sources at regular intervals such as nightly, the system 20 can be adjusted to a different periodicity. In addition, the operator could manually request that the system 20 run the update; for example, a new class of apprentices completes a class at an industrial facility or a large multi-national corporation. It is also recognized that the system could push special access based on necessity, such as a medical issue may result in an automatic push through the system 20 of allowing certain qualified personnel access to locations where they are not typically granted.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

It is recognized that the dynamic rate of changes to individual credentials is dependent on the environment. For example, in some systems a person could work months or years without a change. In contrast, a system at educational institute would have changes related to students that would occur fairly regularly as students enroll in new courses and potentially drop or change sections. Likewise a large industrial complex where employees switch from project to project could have changes weekly or daily.

What is claimed:

1. A security system for allowing access to secure areas, the system comprising:
at least one access control device for controlling the flow of persons in a physical setting to at least one secure area;
an access control database containing information regarding criteria for allowing access to the at least one secure area;
a control system for receiving information from the at least one access control device and comparing the information to the access control database to determine if access is to be granted; and
a rules unit for gathering information from various sources and updating the access control database.

2. A security system of claim 1 wherein the rules unit includes:
a mechanism for gathering information from other databases;
a mechanism for updating a database related to personnel; and
a mechanism for updating the access control database.

3. A security system of claim 1 wherein the rules unit has a personnel database and an organizational database for use in determining the settings in the access control database.

4. A security system of claim 1 wherein the periodicity of the rules unit gathering information and updating the access control database can be varied.

5. A method of dynamically updating access rights comprising:
providing an access control database containing information regarding criteria for allowing access through an at least one access control device to at least one secure area;
gathering information related to personnel from at least one source;
updating a personnel access database related to personnel based on the gathered information; and
updating the access control database by running information from the personnel access database through a rules engine that contains criteria for at least one access control device.

6. A method of dynamically updating access rights of claim 5 wherein the rules engine uses both the personnel access database and an organizational database in determining the criteria for the at least one access control device.

7. A method of dynamically updating access rights of claim 5 wherein the sources are a plurality of databases.

8. A method of dynamically updating access rights of claim 7 wherein the plurality of record databases are selected from the group of training, project, and human resources.
